(19) United States
(12) Patent Application Publication
(10) Pub. No.: US 2011/0250963 A1
(43) Pub. Date: Oct. 13, 2011

(54) GAMING SYSTEM

(76) Inventors: Donald Bauer, Las Vegas, NV (US); James William Morrow, Las Vegas, NV (US)

(21) Appl. No.: 13/081,686

(22) Filed: Apr. 7, 2011

Related U.S. Application Data
(60) Provisional application No. 61/322,051, filed on Apr. 8, 2010.

(51) Int. Cl. A63F 13/00; A63F 9/24; A63F 13/08

(52) U.S. Cl. 463/35; 463/46; 463/36; 463/42

(57) ABSTRACT

A gaming system comprising a gaming machine, a switching mechanism connected between a game controller and an audio visual output device, and an external controller in data communication with the game controller via a first communications link and connected via a second communications link to the switching mechanism. The gaming system is arranged such that, in a first mode, the game controller generates first game events based on the player input and outputs first audio visual data related to the first game events, and the gaming system controls the switching mechanism such that the first audio visual data is routed to the audio visual output device, and, in a second mode, the external controller generates second game events and outputs second audio visual data related to the second game events on the second communications link, and the gaming system controls the switching mechanism such that the second audio visual data is routed to the audio visual output device.

### RELATED APPLICATIONS

This application claims priority to U.S. Provisional Application No. 61/322,051, having a filing date of Apr. 8, 2010, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to a gaming system.

Gaming machines allow a player to play a game such a spinning reel game. Gaming machines may be connected to a controller such as a bonus or jackpot controller to enable a player to obtain an additional award, however there is either no or limited interaction between the player of the gaming machine and the controller in existing configurations.

### BRIEF SUMMARY OF THE INVENTION

In a first aspect, the invention provides a gaming system comprising:

(a) a gaming machine comprising:
a cabinet;
a game controller disposed within the cabinet;
an audio visual output device;
at least one input device mounted to the cabinet for receipt of a player input;

(b) a switching mechanism connected between the game controller and the audio visual output device; and

(c) an external controller external of the cabinet, the external controller in data communication with the game controller via a first communications link and connected via a second communications link to the switching mechanism,
the gaming system arranged such that, in a first mode, the game controller generates first game events based on the player input and outputs first audio visual data related to the first game events, and the gaming system controls the switching mechanism such that the first audio visual data is routed to the audio visual output device, and, in a second mode, the external controller generates second game events and outputs second audio visual data related to the second game events on the second communications link, and the gaming system controls the switching mechanism such that the second audio visual data is routed to the audio visual output device.

In an embodiment, the switching mechanism is disposed within the cabinet.

In an embodiment, the audio visual output device comprises at least one speaker and the first and second audio visual data respectively comprise first and second sound data.

In an embodiment, the audio visual output device comprises an electronic display and the first and second audio visual data respectively comprise first and second display data.

In an embodiment, the electronic display comprises a first display and a second display.

In an embodiment, the second display data is output on the same display or displays of the first and second displays as the first display data.

In an embodiment, the second display data is output on a different display of the first and second displays to the first display data.

In an embodiment, the first display data is output on both the first and second displays and second game display data is output on one of the first and second displays.

In an embodiment, the switching mechanism comprises a first video switch comprising a first input connected to a first video output of the game controller and a video output connected to a video input of the first display.

In an embodiment, the switching mechanism comprises a second video switch comprising a first input connected to a second video output of the game controller and a video output connected to a video input of the second display.

In an embodiment, the second communication link connects a first external controller video output to a second input of the first video switch.

In an embodiment, the second communication link connects a first external controller video output to a second input of the second video switch.

In an embodiment, the second communication link connects a second external controller video output to a second input of the second video switch.

In an embodiment, the first communications link comprises a communication network.

In an embodiment, the second communications link comprises an audio visual cable.

In an embodiment, the audio visual cable is adapted to carry one, or a combination of a component video signal, a composite video signal, an s-video signal, an HDMI signal, an analogue audio signal and a digital audio signal.

In an embodiment, the at least one input device comprises a touch screen.

In an embodiment, the at least one input device comprises at least one button.

In an embodiment, the gaming system comprises a plurality of gaming machines each connected to the external controller to operate in the first and second modes.

In an embodiment, the game controller generates first game events by conducting play of a first game.

In an embodiment, the external controller generates second game events by conducting play of a second game.

In an embodiment, the external controller generates second game events by generating bonus events.

In an embodiment, in the second mode, the external controller generates the second game events based on the player input.

In an embodiment, the at least one input device is in data communication with the game controller to provide the player input to the game controller, and the game controller passes at least part of the player input to the external controller via the first communication link to enable the external controller to generate second game events based on the player input.

In an embodiment, the game controller and the external controller communicate in order to synchronize operation between the first and second modes.

In a second aspect, the invention provides a gaming machine comprising:
a cabinet;
a game controller disposed within the cabinet, the game controller adapted to be placed in data communication with an external controller;
an audio visual output device;
at least one input device mounted to the cabinet for receipt of a player input;
a switching mechanism connected between the game controller and the audio visual output device the switching mechanism also adapted to be connected to
the external controller,
the gaming machine arranged such that, in a first mode, the game controller generates first game events based on the player input and outputs first audio visual data related to the first game events, and the gaming machine controls the switching mechanism such that the first audio visual data is routed to the audio visual output device, and, in a second mode, the switching mechanism is controlled such that second audio visual data from the external controller is routed to the audio visual output device.

In an embodiment, the switching mechanism is disposed within the cabinet.

In an embodiment, the audio visual output device comprises at least one speaker and the first and second audio visual data respectively comprise first and second sound data.

In an embodiment, the audio visual output device comprises an electronic display and the first and second audio visual data respectively comprise first and second display data.

In an embodiment, the electronic display comprises a first display and a second display.

In an embodiment, the second display data is output on the same display or displays of the first and second displays as the first display data.

In an embodiment, the second display data is output on a different display of the first and second displays to the first display data.

In an embodiment, the first display data is output on both the first and second displays and second game display data is output on one of the first and second displays.

In an embodiment, the switching mechanism comprises a first video switch comprising a first input connected to a first video output of the game controller and a video output connected to a video input of the first display.

In an embodiment, the switching mechanism comprises a second video switch comprising a first input connected to a second video output of the game controller and a video output connected to a video input of the second display.

In an embodiment, the at least one input device comprises a touch screen.

In an embodiment, the at least one input device comprises at least one button.

In an embodiment, the game controller generates first game events by conducting play of a first game.

In an embodiment, the at least one input device is in data communication with the game controller to provide the player input to the game controller, and the game controller is adapted in the second mode to pass at least part of the player input to the external controller to enable the external controller to generate second game events based on the player input.

In an embodiment, the game controller is arranged to communicate with the external controller in order to synchronize operation between the first and second modes.

In a third aspect, the invention provides an external controller for a gaming system comprising

(a) a gaming machine comprising:
a cabinet;
a game controller disposed within the cabinet;
an audio visual output device;
at least one input device mounted to the cabinet for receipt of a player input; and

(b) a switching mechanism connected between the game controller and the audio visual output device, the gaming system arranged such that the game controller generates first game events based on the player input and outputs first audio visual data related to the first game events,
the external controller being adapted to be placed in data communication with the game controller via a first communications link and adapted to be connected via a second communications link to the switching mechanism, the external controller arranged to generate second game events and output second audio visual data related to the second game events on the second communications link, and to control the switching mechanism such that the second audio visual data is routed to the audio visual output device.

In an embodiment, the external controller generates second game events by conducting play of a second game.

In an embodiment, the external controller generates second game events by generating bonus events.

In an embodiment, in the second mode, the external controller generates the second game events based on the player input.

In an embodiment, the external controller is arranged to communicate the game controller in order to synchronize operation between the first and second modes.

### BRIEF DESCRIPTION OF SEVERAL VIEWS OF THE DRAWINGS

An exemplary embodiment of the invention will now be described with reference to the accompanying drawings in which:

FIG. 1 is a perspective view of a stand alone gaming machine;

FIG. 1 is a block diagram of the functional components of a gaming machine;

FIG. 2 is a schematic diagram of the functional components of a memory;

FIG. 3 is a schematic diagram of a gaming system;

FIG. 5 is a block diagram of a gaming system; and

FIG. 6 is a block diagram of an external controller.

### DETAILED DESCRIPTION OF THE INVENTION

Referring to the drawings, there is shown, in one embodiment, a gaming system 400 with at least one gaming machine 410 and an external controller 440 such as a feature or bonus controller. In the embodiments, a game controller 420 of the gaming machine 410 and the external controller 440 are each connected to one or more audio visual outputs of the gaming machine via a switching mechanism 460. In an advantageous embodiment, the audio visual outputs are the display or displays 426,427 of the gaming machine 410. An audio visual output may be solely a video output, may be solely an audio output or may be both an audio and visual output. The game controller 420 is also connected to the external controller 440 so that player inputs to the gaming machine can be passed to the external controller.

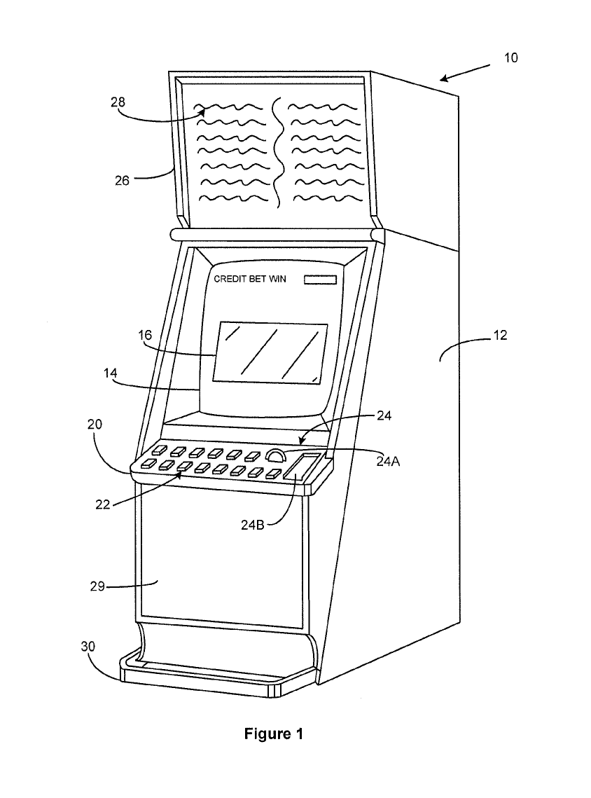

A gaming machine 10 is illustrated in FIG. 1. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may be configured for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 1 is in the form of a video display unit, particularly a liquid crystal display LCD cathode ray tube screen device. Alternatively, the display 14 may be a cathode ray display, plasma screen, any other suitable video display unit. The top box 26 may also include a second display, for example a video display unit, which may be of the same type as the display 14, or of a different type. In embodiments where there is a second display, display 14 may be provided by the visible portion of an electromechanical device such as the reels of a stepper gaming machine. Speakers are also mounted within the cabinet to output sound to accompany play of a game.

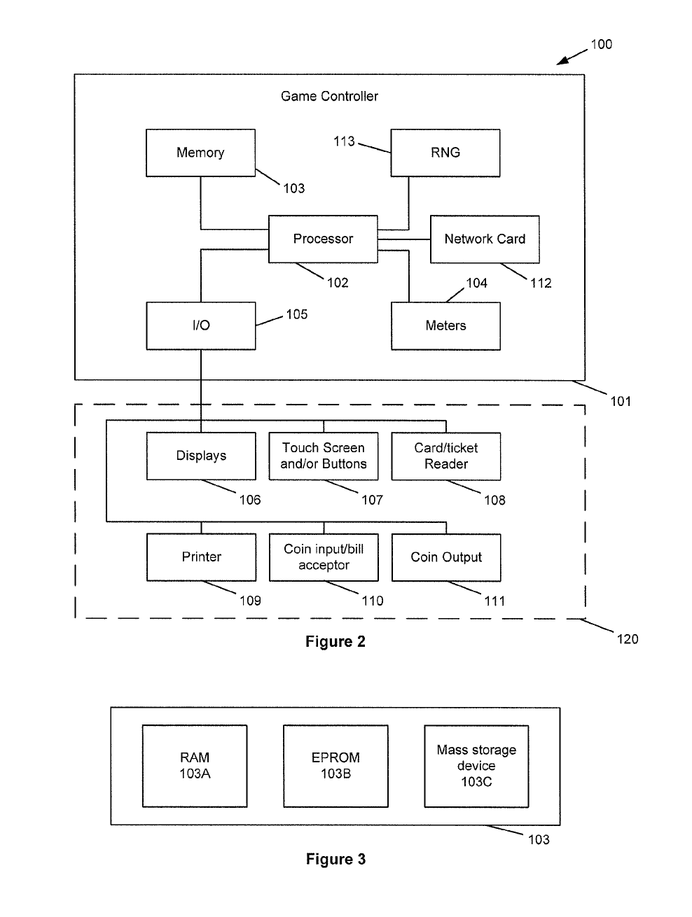

FIG. 2 shows a block diagram of operative components of a typical gaming machine which may be the same as or different to the gaming machine of FIG. 1.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

The gaming machine 100 has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 2, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game, any input device that enables the player to input game play instructions may be used. For example, in some gaming machines a mechanical handle is used to initiate a play of the game.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

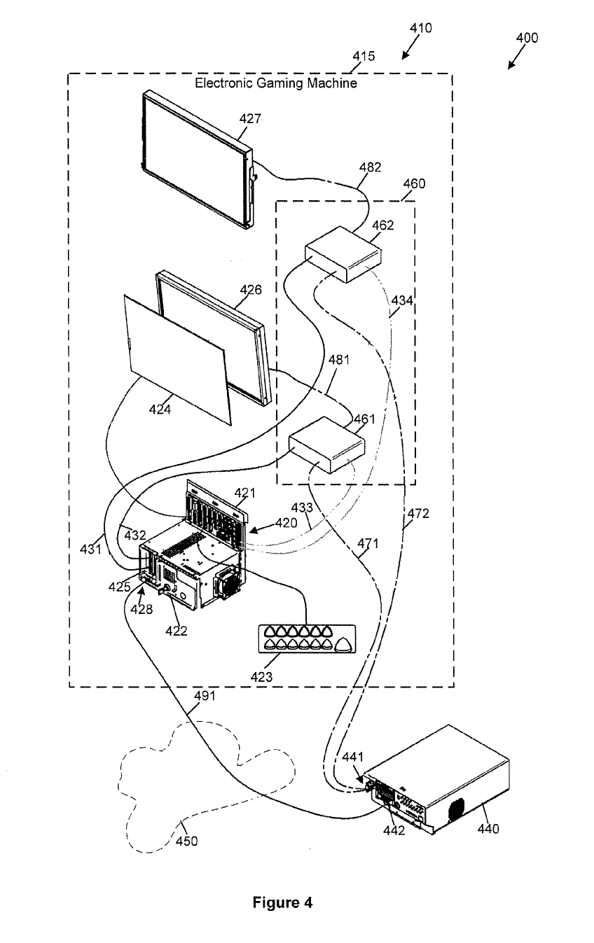

FIG. 3 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

FIG. 4 shows a gaming system 400 schematically and shows that a gaming machine 410 has a number of components mounted within a cabinet 415. The gaming machine 400 is generally constructed in a similar fashion to the gaming machines 10,100 described above but various components are not shown to facilitate description of the gaming system. Components of those gaming machines 10,100 may be found in gaming machine 400 or varied in accordance with gaming machines known in the art.

Mounted within the cabinet 415 is a game controller unit 420 having a main board 422 and a back plane 421. As indicated above in relation to FIG. 2, the game controller unit 420 comprises a processor and memory which are mounted to the main board 422. Backplane 421 allows power to be connected to the main board 422 and also provides the primary means for connecting the main board 422 to other components of the gaming machine 410 including the button deck 423 and the touch screen 424. The game controller unit 420 also has a video output 425 to enable the game controller 420 to output video data to an electronic display which is provided by first liquid crystal display 426 and a second liquid crystal display 427. In the embodiment, video data is output in a component video format but persons skilled in the art will appreciate that other analogue video formats compatible with the displays 426, 427 may be employed such as composite video or s-video as may digital formats such as HDMI (high-definition multimedia interface).

It will be apparent from FIG. 4 that the video output 425 is connected to two video cables 431, 432. Each of these video cables are connected to the respective first inputs of a first video switch 461 and a second video switch 462. The outputs of the video switches 461,462 are connected by video cables 481, 482 respectively to the video inputs of the first liquid crystal display 426 and the second liquid crystal display 427 respectively.

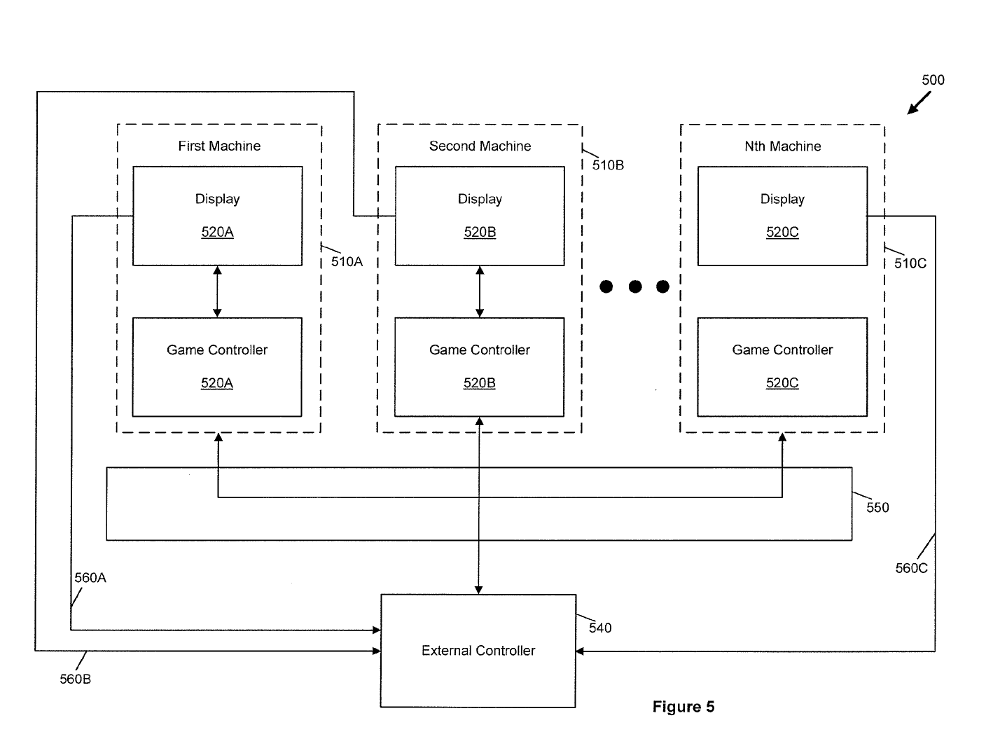

The second inputs of the first switch 461 and the second switch 462 are connected by video cables 471, 472 to the video output 441 of an external controller 440 of the gaming system which is located outside the cabinet. The video cables 471, 472 providing a second communications link to the external controller 440. The external controller 440 is preferably located close to the gaming machine 410, for example in cabinetry surrounding a bank of gaming machines to enable it to service the plurality of gaming machines of the bank as described below in relation to FIG. 5. In the embodiment, a separate control line 433, 434 is provided between the game controller unit 420 and the switches 461,462 to enable control of the switches. In another embodiment control lines may be provided between the external controller 440 and the switches 461, 462. In another embodiment, one or more of the video cables 431, 432, 471, 472 can also carry a control line.

It will be appreciated that the first switch 461 and the second switch 462 provide a switching mechanism 460 which allows for the selective control of the video source for each of the first display 426 and the second display 427.

The game controller unit 420 is also connected via a first communications link 491 to the external controller 440. In the embodiment, the game controller 420 has an output 428 in the form of an Ethernet port connecting the gaming machine to a network 450 and hence to an Ethernet port 442 of the external controller 440. The communications link 491 enables direct communication between the game controller unit 420 and the external controller. The purpose of the direct communication is to enable both the game controller unit 420 and the external controller unit 440 to generate game events and for these to be displayed on displays 426, 427. In order to achieve this, the game controller 420 and the external controller 440 communicate with one other to enable synchronisation of the generation and display of game events by one another and to synchronise control of the video switches and hence the displayed input. The link 491 also enables communication from the game controller unit of inputs made by the player using either the button deck 423 or the touch screen 424 which are relevant to game events being generated by the external controller 440.

In one embodiment, the communications link 491 uses a TCP/IP and XML base protocol. One technique which can be used is to use the gaming standards association G2S protocol with extensions to existing XML messaging to enable the relevant functions.

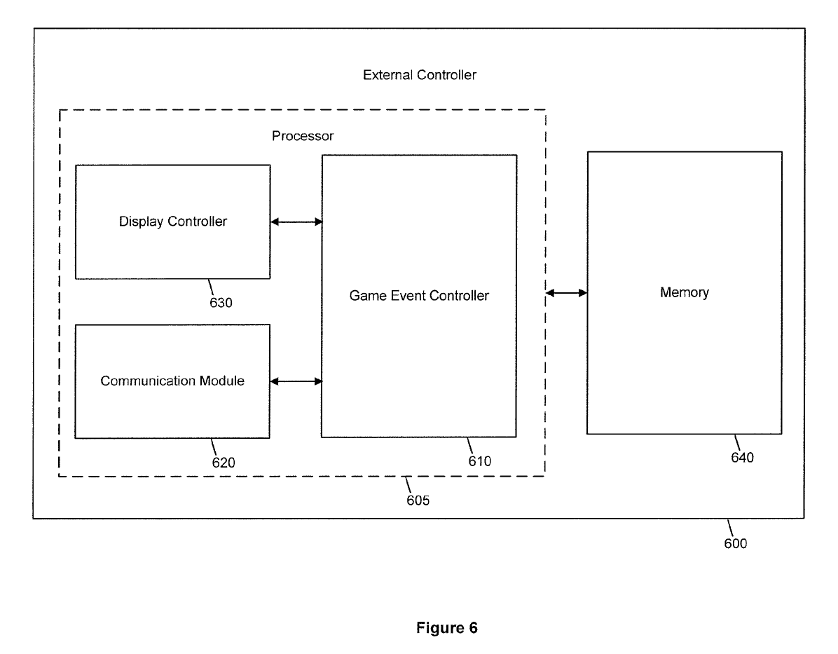

An advantage of connecting the gaming machine 410 and the external controller 440 in this manner is that it allows normal gaming machine functions to be carried out until an event occurs on one of the game controller unit 420 or the external controller 440 such as a trigger event. Once the trigger event occurs, the video for display is sourced from the external controller 440. A player can then interact with external controller 440, for example by touching the relevant part of touch screen 424 and this player input can be sent to the external controller 440. As illustrated in FIG. 6, the external controller 600 is implemented by a processor implementing instructions stored in a memory 640 in an analogous fashion to the game controller shown in FIG. 2. Other features analogous to those shown in FIG. 2 can also be incorporated within the external controller 600. The processor 605 of the external controller 600 implements a number of modules. Events are generated by the external controller game event controller 610 based on communications with the game controller unit via a communication module 620 over communication link 491. Display controller 630 communicates with the switches and hence the displays 426,427 via the second communication link provided by the video cables 471, 472.

Persons skilled in the art will appreciate that control of the displays 426, 427 is one form of control of an audio visual output which can achieved by this technique and that audio outputs may be controlled (additionally or alternatively) in the same manner. The audio output may be an analogue audio signal or a digital audio signal such as pulse coded modulation (PCM) which could be transmitted, for example, using an HDMI cable.

Persons skilled in the art will appreciate that there are a number of configurations that can be used. For example, the game controller unit 420 may use one or both of the first and second displays 426, 427. Similarly, the external controller 440 may use one or both of the displays 426, 427. In one embodiment, the game control unit uses both displays whereas the second external controller 440 only uses one of the displays. In embodiments where both of the controllers 420, 440 only use one display, they may use the same display.

In one example, the game provided by the gaming machine 410 may be a spinning reel game such as are known in the art where the player selects, depending on the specific implementation a number of win lines or reels to play and a wager to place per win line or reel. The game controller then determines a game outcome by spinning the reels to a stop and comparing the symbols on the reels against the selected win lines and a pay table to determine whether to make an award to the player. In such an embodiment, the spinning reel game may provide a base game and there may be an opportunity to trigger a feature game from the base game. The trigger condition may be one of several trigger conditions known in the art such as a symbol combination occurring within the base game or a random determination result.

In such an embodiment, the external controller 440 may act as a feature controller for carrying out the feature game. Accordingly, once the trigger condition occurs, the game control unit 420 communicates with the external feature controller 440 and it takes over control of the first and second displays 426, 427 for playing of a feature game. Outcomes of the feature game may be displayed on second display 427 while the first display 426 is used to display items requiring a player to make selections using the touch screen 424. The player makes selections with the touch screen 424 and the game controller unit 420 passes the selections by a first communication link 491 to the external controller 440. The game event controller 610 processes the selections in accordance with instructions stored in the memory 640 and determines what to display on the second display 427 and display data is output via display controller 630 to the relevant display. Any awards are communicated via the communication module 620 to the game controller unit 420 so that it can update relevant meters.

The base game is a part of the game which is carried out each time the player makes a wager, typically irrespective of the wager, whereas other parts of the game will only be carried out occasionally for example if a condition is met such as a trigger occurring or if an ante bet is placed (depending on the specific embodiment).

Persons skilled in the art will appreciate that a feature game involves some additional element of game play which usually only occurs when a trigger condition is met. Types of feature games include: those where a series of free game events are awarded such as free games or re-spins (where some reels are held while others are re-spun); games where the symbols on the reel are changed; and “second screen” games where game play is totally different to the base game, for example where the player makes selections in a “pick a box type” game.

In another example, the external controller may be a bonus controller which is arranged to randomly determine whether to make awards to one of a plurality of connected gaming machines as shown in FIG. 5. Referring to FIG. 5 the external controller 540 is connected by a first communication link in the form of network 550 to each of a first gaming machine 510A, second gaming machine 510B and an eighth gaming machine 510C.

Each gaming machine has a display 520 and a game controller 530. The external controller is connected to each of these displays via switches (not shown in FIG. 5) by a first video cable 560A, second video cable 560B and a third video cable 560C respectively.

In such an embodiment, the external controller 540 may randomly determine whether to make an award to one connected gaming machines 510. Once the external controller 540 determines to make an award to one of the gaming machines it communicates to the relevant one of the game controllers 520. The communication is primarily so that the game controller 520 can advise the external controller 540 when it may take over control of the display. However, the communication may be for other purposes, for example, to establish whether the relevant gaming machine 510 is eligible based on eligibility criteria, such as having placed a wager within a defined period. Once the game controller 520 advises the external controller 540 that it can take over control, the external controller 540 takes over the display by controlling the switching mechanism and displays the bonus award on display 520 of the relevant gaming machine. It will be appreciated that such a bonus award may or may not require further player interaction. Where player interaction is required, input from the relevant input device of the relevant gaming machine is passed to the external controller 540 as described above in relation to FIG. 4.

It will be appreciated in such embodiments, that the external controller 540 may synchronise display of the bonus award across the plurality of gaming machines 510, display it only on the participating gaming machine, display it on both displays of a winning machine while only on a secondary display of non-winning gaming machines etc.

Persons skilled in the art will appreciate that there are a number of advantages of certain embodiments of the invention. One advantage, the main display of the gaming machine may be shared between the game controller and the external controller and be under control of both of the game controller and the external controller for both video and user input. Another advantage is the touch screen of the main display may be used to provide control signals to the external controller.

Further, user input for multiple games can be sent to the external controller and acted upon with resulting shared and/or individual video output and sound.

As the game controller unit 420 is placed in the middle of touch interactions and is in communication with the external controller 440, it is aware of the games state at all times and can take over control of events when and if required (and/or desired). The game controller can also provide game replay.

A further advantage is that the technique enables new categories of games to be played at a gaming machine 410, including multiplayer games with user input and participation. The technique can also be used to access other systems.

In addition to the above described embodiments, the external controller could be a jackpot controller. In other embodiments, additional switches may be provided in conjunction with the input devices so that control of the input devices can be shared between the game controller and the external controller in a manner analogous to control of the displays.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming system comprising:
(a) a gaming machine comprising:
a cabinet;
a game controller disposed within the cabinet;
an audio visual output device;
at least one input device mounted to the cabinet for receipt of a player input;
(b) a switching mechanism connected between the game controller and the audio visual output device; and
(c) an external controller external of the cabinet, the external controller in data communication with the game controller via a first communications link and connected via a second communications link to the switching mechanism,
the gaming system arranged such that, in a first mode, the game controller generates first game events based on the player input and outputs first audio visual data related to the first game events, and the gaming system controls the switching mechanism such that the first audio visual data is routed to the audio visual output device, and, in a second mode, the external controller generates second game events and outputs second audio visual data related to the second game events on the second communications link, and the gaming system controls the switching mechanism such that the second audio visual data is routed to the audio visual output device.

2. A gaming system as claimed in claim 1, wherein the switching mechanism is disposed within the cabinet.

3. A gaming system as claimed in claim 1, wherein the audio visual output device comprises at least one speaker and the first and second audio visual data respectively comprise first and second sound data.

4. A gaming system as claimed in claim 1, wherein the audio visual output device comprises an electronic display and the first and second audio visual data respectively comprise first and second display data.

5. A gaming system as claimed in claim 4, wherein the electronic display comprises a first display and a second display.

6. A gaming system as claimed in claim 5, wherein the second display data is output on the same display or displays of the first and second displays as the first display data.

7. A gaming system as claimed in claim 5, wherein the second display data is output on a different display of the first and second displays to the first display data.

8. A gaming system as claimed in claim 5, wherein the first display data is output on both the first and second displays and second game display data is output on one of the first and second displays.

9. A gaming system as claimed in claim 4, wherein the switching mechanism comprises a first video switch comprising a first input connected to a first video output of the game controller and a video output connected to a video input of the first display.

10. A gaming system as claimed in claim 4, wherein the switching mechanism comprises a second video switch comprising a first input connected to a second video output of the game controller and a video output connected to a video input of the second display.

11. A gaming system as claimed in claim 9, wherein the second communication link connects a first external controller video output to a second input of the first video switch.

12. A gaming system as claimed in claim 10, wherein the second communication link connects a first external controller video output to a second input of the second video switch.

13. A gaming system as claimed in claim 10, wherein the second communication link connects a second external controller video output to a second input of the second video switch.

14. A gaming system as claimed in claim 1, wherein the first communications link comprises a communication network.

15. A gaming system as claimed in claim 1, wherein the second communications link comprises an audio visual cable.

16. A gaming system as claimed in claim 15, wherein the audio visual cable is adapted to carry one, or a combination of a component video signal, a composite video signal, an s-video signal, an HDMI signal, an analogue audio signal and a digital audio signal.

17. A gaming system as claimed in claim 1, wherein the at least one input device comprises a touch screen.

18. A gaming system as claimed in claim 1, wherein the at least one input device comprises at least one button.

19. A gaming system as claimed in claim 1, comprising a plurality of gaming machines each connected to the external controller to operate in the first and second modes.

20. A gaming system as claimed in claim 1, wherein the game controller generates first game events by conducting play of a first game.

21. A gaming system as claimed in claim 1, wherein the external controller generates second game events by conducting play of a second game.

22. A gaming system as claimed in claim 1, wherein the external controller generates second game events by generating bonus events.

23. A gaming system as claimed in claim 1, wherein, in the second mode, the external controller generates the second game events based on the player input.

24. A gaming system as claimed in claim 23, wherein the at least one input device is in data communication with the game controller to provide the player input to the game controller, and the game controller passes at least part of the player input to the external controller via the first communication link to enable the external controller to generate second game events based on the player input.

25. A gaming system as claimed in claim 1, wherein the game controller and the external controller communicate in order to synchronize operation between the first and second modes.

26. A gaming machine comprising:
a cabinet;
a game controller disposed within the cabinet, the game controller adapted to be placed in data communication with an external controller;
an audio visual output device;
at least one input device mounted to the cabinet for receipt of a player input;
a switching mechanism connected between the game controller and the audio visual output device the switching mechanism also adapted to be connected to the external controller,
the gaming machine arranged such that, in a first mode, the game controller generates first game events based on the player input and outputs first audio visual data related to the first game events, and the gaming machine controls the switching mechanism such that the first audio visual data is routed to the audio visual output device, and, in a second mode, the switching mechanism is controlled such that second audio visual data from the external controller is routed to the audio visual output device.

27. A gaming machine as claimed in claim 26, wherein the switching mechanism is disposed within the cabinet.

28. A gaming machine as claimed in claim 26, wherein the audio visual output device comprises at least one speaker and the first and second audio visual data respectively comprise first and second sound data.

29. A gaming machine as claimed in claim 26, wherein the audio visual output device comprises an electronic display and the first and second audio visual data respectively comprise first and second display data.

30. A gaming machine as claimed in claim 29, wherein the electronic display comprises a first display and a second display.

31. A gaming machine as claimed in claim 30, wherein the second display data is output on the same display or displays of the first and second displays as the first display data.

32. A gaming machine as claimed in claim 30, wherein the second display data is output on a different display of the first and second displays to the first display data.

33. A gaming machine as claimed in claim 30, wherein the first display data is output on both the first and second displays and second game display data is output on one of the first and second displays.

34. A gaming machine as claimed in claim 30, wherein the switching mechanism comprises a first video switch comprising a first input connected to a first video output of the game controller and a video output connected to a video input of the first display.

35. A gaming machine as claimed in claim 30, wherein the switching mechanism comprises a second video switch comprising a first input connected to a second video output of the game controller and a video output connected to a video input of the second display.

36. A gaming machine as claimed in claim 26, wherein the at least one input device comprises a touch screen.

37. A gaming machine as claimed in claim 26, wherein the at least one input device comprises at least one button.

38. A gaming machine as claimed in claim 26, wherein the game controller generates first game events by conducting play of a first game.

39. A gaming machine as claimed in claim 26, wherein the at least one input device is in data communication with the game controller to provide the player input to the game controller, and the game controller is adapted in the second mode to pass at least part of the player input to the external controller to enable the external controller to generate second game events based on the player input.

40. A gaming machine as claimed in claim 26, wherein the game controller is arranged to communicate with the external controller in order to synchronize operation between the first and second modes.

41. An external controller for a gaming system comprising:
(a) a gaming machine comprising:
a cabinet;
a game controller disposed within the cabinet;
an audio visual output device;
at least one input device mounted to the cabinet for receipt of a player input; and
(b) a switching mechanism connected between the game controller and the audio visual output device, the gaming system arranged such that the game controller generates first game events based on the player input and outputs first audio visual data related to the first game events,
the external controller being adapted to be placed in data communication with the game controller via a first communications link and adapted to be connected via a second communications link to the switching mechanism, the external controller arranged to generate second game events and output second audio visual data related to the second game events on the second communications link, and to control the switching mechanism such that the second audio visual data is routed to the audio visual output device.

42. An external controller as claimed in claim 41, wherein the external controller generates second game events by conducting play of a second game.

43. An external controller as claimed in claim 41, wherein the external controller generates second game events by generating bonus events.

44. An external controller as claimed in claim 41, wherein, in the second mode, the external controller generates the second game events based on the player input.

45. An external controller as claimed in claim 41, arranged to communicate the game controller in order to synchronize operation between the first and second modes.
